(19) United States
(12) Patent Application Publication
(10) Pub. No.: US 2024/0103154 A1
(43) Pub. Date: Mar. 28, 2024

(54) Location Apparatus

(71) Applicant: Zelim Limited, Denbighshire (GB)

(72) Inventors: Samuel Mayall, Denbighshire (GB); Douglas Lothian, Longniddry (GB)

(21) Appl. No.: 18/276,307

(22) PCT Filed: Feb. 8, 2022
(86) PCT No.: PCT/GB2022/050335

§ 371 Date: Aug. 8, 2023

(30) Foreign Application Priority Data
Feb. 8, 2021 (GB) 2101727.2

(51) Int. Cl. G01S 13/86; G01S 17/88

(52) U.S. Cl. CPC G01S 13/865; G01S 13/867; G01S 17/88

(57) ABSTRACT

An apparatus for locating a body includes a plurality of receiving means for receiving emission and/or reflection from the body and for outputting a response in terms of presence and bearing when such emission or reflection is received. It also comprises comparison means for comparing the output response from the different receiving means and generating a body present output if output responses received from at least two of the receiving means indicate substantially the same bearing. The location apparatus also includes memory means for memorising such a body present output as a body location.

The present invention relates to location apparatus and a method of locating a body.

WO2019/158904 discloses an embodiment of an unmanned lifeboat which has a hull with a transom opening, and a fo'c'sle closed by a rounded top deck that is able to provide accommodation for survivors. The aft deck as such is generally U-shaped with a cut-out open at the transom, which is vestigial with two small port and starboard parts. Within the cut-out is a boarding assistance ramp. This is level with the aft deck at its forward end and slopes down to the transom. It extends aft of this by a short distance to enable survivors to swim and crawl onto it.

For guidance to reach the vicinity of the survivors, the lifeboat is equipped with a communication apparatus including a receiver for receiving survivor location data. In addition, the navigation apparatus with which the lifeboat is equipped includes a GPS system of its own, and a compass. The lifeboat is also equipped with a control system. The latter computes a course to the survivors by comparing its and survivor positions. The control unit has an output module for controlling the propulsion units to drive the lifeboat to the survivor position.

In WO2019/158904, the survivor location data came from any of the following:
1. Satellite relayed heading data from a survivor worn PLB (Personal Locator Beacon) or EPIRB (Emergency Position Indicating Radio Beacon) device;
2. The same data, including in addition GPS/latitude and longitude coordinates;
3. Heading and/or coordinate data received direct from a PLB or EPIRB device;
4. Survivor coordinate data received from a base station, typically estimated from a last known position of a survivor transport vehicle such as a helicopter, as from an ELT (Emergency Locator Transmitter) or an SART (Search And Rescue Transponder) or an AIS-SART, an AIS being an Automatic Identification System.

In this specification “radar apparatus” means: apparatus for detecting the presence, direction, distance, and speed of aircraft, ships, and other objects, by sending out pulses of radio waves which are reflected off the object back to the source.

Similarly “lidar apparatus” means: a detection system which works on the principle of radar, but uses light from a laser. Lidar apparatus can operate above or below the surface of water.

As used herein, “velocity” is used to mean vector velocity.

It may be desirable to provide a lifeboat, or any other vessel or user, with a self-contained location apparatus for survivors and the like.

According to a first aspect of the invention there is provided an apparatus for locating a body, comprising:
a plurality of means for receiving emission and/or reflection from the body and for outputting a response in terms of at least one of presence and bearing when such emission or reflection is received,
means for comparing the output response from the different receiving means and generating a body present output if output responses received from at least two of the receiving means indicate substantially the same bearing, and
means for memorising such a body present output as a body location.

The body is preferably a human body, for example, a casualty that is in the water. The location apparatus may have wider application for locating other objects which are in the water.

Preferably at least one of the receiving means is adapted to output a response in terms of body range, whereby the body location can comprise a range and bearing of the body.

The comparing means can be adapted to generate a body present output if one receiving means receives a signal characteristic of its mode of operation at one bearing and another receiving means receives a signal characteristic of its different mode of operation at substantially the same bearing.

For instance, a human body is likely to emitted infra-red emission from the face at least even in a survival suit and the survival suit is likely to have fluorescent and/or reflective strips. The distinction is that a fluorescent/reflective strip can emit visible light in the presence of other light, such as ultraviolet light, visible light or infra-red light. In daylight the fluorescent/reflective strips may be seen in visible light, and in night time conditions the fluorescent strips may be seen using infra-red, for example, using a short wave infra-red transmitter (e.g., transmitting in a wavelength range of 1.3 to 4 μm). Reflective strips would reflect such incident light and produce an output at the receiving means. If a thermal sensor receives emission at a bearing and a visible light sensor receives light with the spectrum expected from fluorescent/reflective strips, the comparing means can output a body present output above a threshold of certainty not able to be reached with a single such output response.

Even without a face being visible, a thermal sensor is expected to be able to sense a temperature difference of a survival suit partially exposed to the air from that of the surrounding sea, at least at closer range. If the casualty is present in the water without a survival suit on then a clearer body image may be seen from the thermal sensor.

The plurality of receiving means may include a plurality of infra-red sensors, each with a sensitivity primarily in a particular range, for example, short wave infra-red range (1.3-4 μm), a medium wave infra-red range (3-8 μm) or a long wave infra-red range (7-14 μm). The receiving means may comprise at least a short wave infra-red receiving means and a long wave infra-red receiving means.

A thermal sensor and a visible light sensor are normally monocular and as such not well adapted to binocular range finding. Whilst they can be combined in binocular form for generating a response indicative of range, we prefer to provide another sensor able to time reflected emission from the sensor, such as a radar or a lidar sensor, for sensing the range of the body.

Alternatively or additionally, the thermal sensor may comprise an infrared (IR) sensor of the transceiver type having an IR emitter. This is able to operate on not only IR emitted by a body, but reflected from it as well. This may be advantageous for locating a body at night using reflective strips on the body. The IR emitter may emit IR light, say, in a short wave range, and the receiving means may be adapted to identify a reflection from a reflective strip on the body in the short wave IR range.

With reflection comes the ability to sense range. Range of the body may also be sensed through other parameters, such as the number of pixels present in a zoomed in image.

Further a reflective sensor, e.g., a transceiver aimed at visible reflections from reflective strips, may be better adapted to providing an output indicative of the shape of the body. If this corresponds to the expected shape of the body, this can be combined in the comparing means to increase the reliability of the body present output to be memorised.

Further provided the range is not too great and/or the thermal and visual sensors are sufficiently sensitive, they can provide an output of shape in much the same way as radar and lidar sensors can.

In the preferred embodiment of the invention all the comparing means are adapted to take account of shape output response from the sensors.

Further, where the sensors can provide shape output in a common format, preferably a visually recognisable image, this can be compared with a collection of possible body images for refining recognition of the body as a human body or not.

The location apparatus may comprise a database of body images.

The body images may be taken at different heights, for example, using images from vessels in real situations, drones or other aircraft. The body images may be taken from different directions, such as upwind, downwind, cross-wind, with the tide or current, against the tide or current, or side on to the tide or current. The body images may be of bodies wearing different types of clothing, for example, full survival suits or regular clothing. The images may be taken under a variety of sea states ranging from smooth to an extreme storm. The body images may be taken under different lighting conditions, from full daylight through to night time conditions. The body images may also comprise different images taken using the different receiving means. The body images may comprise full body images as well as head images. They may also comprise images of different survival clothing. Depending on the clothing and survival equipment worn by the casualty, the casualty may be floating in a face up configuration or may be in some other configuration. The comparison means can use image recognition and/or AI techniques to match images output from the receiving means against images in the database.

According to another aspect of the invention there is provided a method for locating a body using an apparatus for locating a body in accordance with any preceding statement, the method comprising:
receiving emission and/or reflection from a body at the plurality of receiving means for receiving emission and/or reflection from the body;
outputting from the receiving means a response in terms of presence and bearing when such emission or reflection is received;
comparing the output response from the different receiving means with the comparison means for comparing the output responses;
generating a body present output with the comparison means if output responses received from at least two of the receiving means indicate substantially the same bearing; and
memorising such a body present output as a body location at the memory means for memorising.

The methods associated with the use of the location apparatus may include the step of building a collection of body images suitable for use in the location apparatus. The methods may also include the step of matching one or more body images with an output response received from at least one of the receiving means.

According to a further aspect of the invention there is provided apparatus for locating a body, comprising:
means for receiving data from the body in terms of at least one of presence, range and bearing thereof from each of the following included in the data receiving means:
   a visible light image receiver or camera
   an infrared or thermal image camera, receiver or transceiver
   radar apparatus and/or lidar apparatus and
means for processing data from the individual ones of the receiving means and combining it to form combined range and bearing a body present.

Preferred features of the earlier aspects can be freely combined with the features described in relation to this aspect and vice versa.

Preferably the apparatus includes means for creating an electronic image of the body present and its bearing.

Preferably the apparatus is adapted to discriminate between a plurality of bodies present and identify them separately, as by them individually presenting a different of imagine at any one point in time and/or having a perceptibly different range and/or bearing.

The apparatus preferably includes means for memorising characteristics of a type of body and comparing the electronic image of the or each of the bodies present to identify them as of the type.

Further apparatus preferably includes means for tracking changes in range and bearing of the individual bodies present.

The apparatus preferably includes inputs for a boat vessel or craft, hereinafter the “Vessel”, on which the apparatus is installed as the velocity and heading of thereof, the apparatus being adapted to compute the velocity of the or each body present.

Further the apparatus is adapted to output conning data to the Vessel to cause it to approach and then to keep station with the bodies present, coming no closer than a specified distance or “electronic fence” from any one of them. For instance if the bodies are drifting at a certain velocity, and the Vessel has a greater windage, it will keep station at the electronic fence compensating with its propulsion system for the windage.

In addition to identify the bodies as of an expected type, whilst at the electronic fence, or whilst approaching it the location apparatus will be adapted to monitor the surface of the water for floating and/or partially submerged wreckage or other objects. It can be adapted to grade such objects as large and to be avoided and small and to be ignored bearing in mind that wreckage is often semi-submerged as upturned craft often are.

The apparatus is preferably further adapted to compute an approach to each body of the expected type to recover them one after the other, normally autonomously and normally with a recovery ramp/conveyor of the type described in our above referenced WO2019/158904, or the like ramp/conveyor.

To help understanding of the invention, a specific embodiment thereof will now be described by way of example only and with reference to the accompanying drawings, in which:

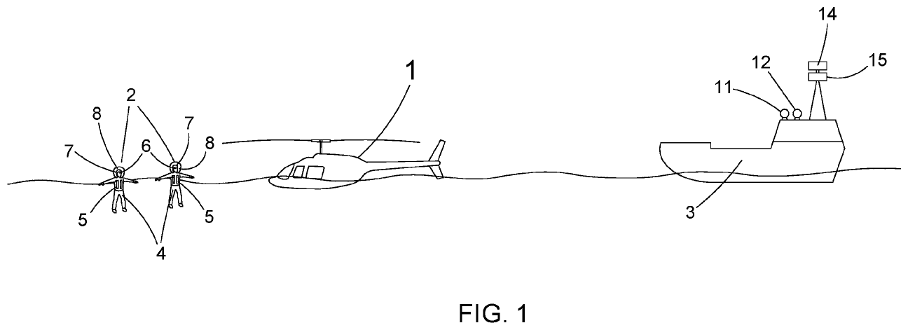

FIG. 1 is a diagrammatic view of survivors and rescue vessel;

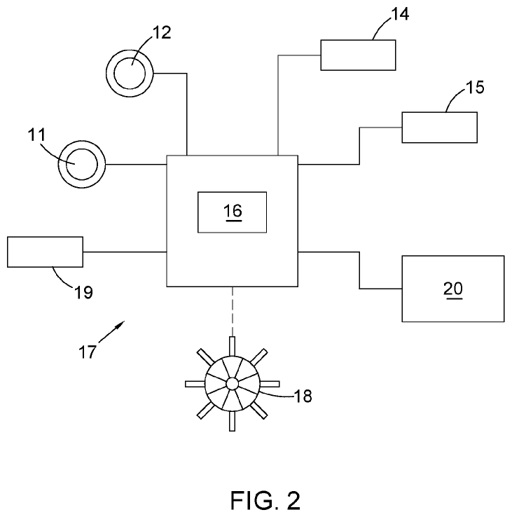

FIG. 2 is a diagram of location apparatus of the invention and

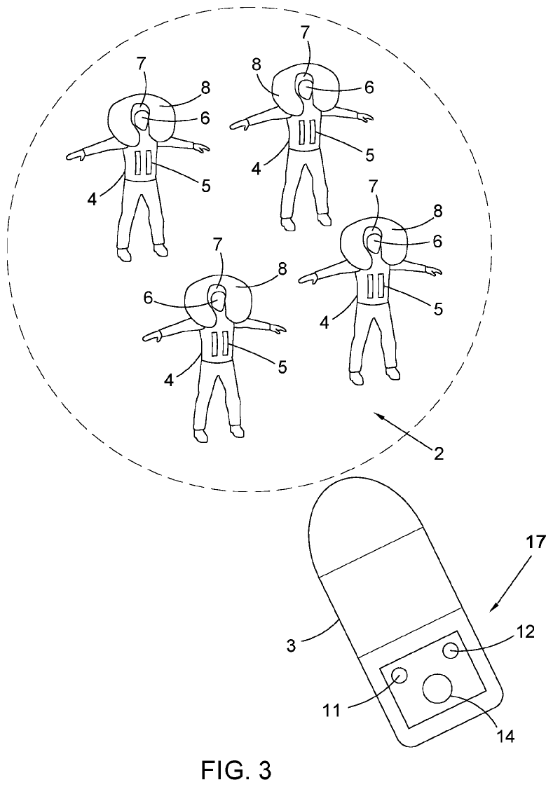

FIG. 3 is a diagrammatic view of the location apparatus holding the rescue vessel at an electronic fence around the survivors.

Referring to the drawings, wreckage 1 of a ditched aircraft and survivors 2 from it are floating on the sea. A rescue vessel 3 is looking for them. The survivors 2 are wearing survival suits 4 having fluorescent and/or reflective strips 5 and an opening 6 in a hood 7 for the wearer's face. The survivors 2 are clearly visible in good light, their fluorescent/reflective strips 5 are visible in poorer light. Their faces are visible to a thermal camera, with their survival suits less visible due to their insulation. Nevertheless they may be visible, if warmed by ambient air for instance. If the survivor 2 is without protective clothing then they may be easier to see. The survivors' body shape may also be perceptible to radar and lidar, to an extent, depending on their orientation and height in the water. They may float on their back with their face up, held there by lifebuoys 8.

The vessel 3 is autonomous and equipped with predominantly forward facing visible light and thermal cameras 11,12 and radar and lidar scanners 14,15. While just one each of these cameras 11,12,14,15 is shown for simplicity coupled to the location apparatus 17, the location apparatus 17 may comprise a plurality of any such cameras. In particular, the location apparatus 17 may comprise multiple visible light cameras and thermal cameras 11,12 (receiving means). In this way, the multiple cameras 11,12 can be used to generate images that allow different fields of view, for example, a wide field of view of greater than 50° and narrower fields of view which are more focused on a region of interest, for example less than 30°. The different cameras 11,12 may be directed in different directions, for example, to build up a wider field of observation, e.g., up to 180°, 270° or even 360°. The different cameras 11,12 may be used to help improve resolution of the image output. The different cameras 11,12 may have maximum sensitivities in different wavelength regions to allow the received images to identify the body by observing different parts of the body images. The processing portion 16 may contain a database or library 20 of body images that are used to locate the body.

Locating a body may be seen as one or more of detecting, identifying and/or observing a body.

These four cameras 11,12,14,15 are in communication with a processing portion 16 of location apparatus 17. The communication can be hardwired when the processing portion is on board or wireless when the processing portion is remote as envisaged to be entirely feasible. Either is possible and no distinction is made here. The full lines used in FIG. 2 to connect the four cameras 11,12,14,15 to a processing portion 16 of the location apparatus 17 may be seen as representing hardwired connections, wireless connections or a mixture of hardwired and wireless connections.

On launch or deployment, as in our earlier application, the vessel's conning system 18 will initially steer the vessel towards the GPS position of the survivors' PLBs or the like, if such position is known or otherwise towards the survivors. Where GPS position is known it will be used to within 1 kilometre of the GPS position. Where GPS data is not available for any reason, the PLB transmission can still be used with direction finding equipment 19 on board to reach the same distance from the survivors where on one of the sensors 11,12,14,15 is expected to be able to see the survivors. As soon as this occurs, the sensor's bearing data is added to that of the RDF equipment 19 or the GPS position and the boat is conned towards the survivors. As the survivors are approached, where there are more than one, their individual bearings from the boat will deviate and at this stage the location apparatus 17 will tag them individually.

The processing portion 16 of the apparatus 17 operates at two levels. The first relies on the different nature of detection from the survivors 2. The thermal camera 12 is well adapted to detect at least the faces of the survivors 2 and is able to determine the relative bearing of them with respect to the vessel's heading, or at least those of them facing the vessel 3. The thermal camera 12 may be able to pick up more than just the face of the survivor 2 depending on the clothing of the survivor 2 and the sea conditions. Visible light camera 11 is well adapted to detect the survivors 2 on good light and reasonably well adapted to detect them in deteriorating light. In particular it is well adapted to detect the fluorescent/reflective strips 5 on the survivors' survival suits and or lights on them. It also can measure relative bearing of the survivors 2. At night time or in poor light conditions, an infra-red transmitter may be used to illuminate the scene and cause reflections to emit from reflective strips 5 on the survivors 2 which can be received by infra-red receiving means on the location apparatus 17. Infra-red illumination can produce an image with greater resolution of distance than with visible light. In a preferred embodiment a transmitter will be used to illuminate the area of view with a wavelength in the range of 1.3-4 μm. It may also be beneficial to illuminate the area with a long wave infra-red radiation in the range of 8-12 μm.

For four survivors, the cameras 11,12 may not detect individual emitted thermal and visual images as the vessel 3 first approaches them from a distance. The processing unit 16 will though receive outputs from both indicating faces and fluorescent strips 5 on the same bearing and will determine with initial probability that there is a survivor present. The vessel 3 will be conned, either autonomously or remotely, towards the survivors 2. As it approaches the cameras 11,12 will discriminate that there is more than one survivor 2. The processing unit 16 may receive a different count of survivors 2 at their bearings due for instance to them facing different directions. It will memorise the number of survivors 2 having both visual and thermal outputs from the cameras 11,12 and electronically tag them and track their relative movement with respect to the vessel 3.

Arranging the cameras 11,12 as binocular pairs, gives accurate indications of range. Other range sensing measures can also be employed, such as using range detectors and using the image itself to determine the range, for example through counting the number of pixels that are visible when the image is zoomed in on. In favourable weather, the cameras 11,12 may also enable a remote coxswain to manoeuvre the vessel to within a clear view of the survivors 2.

At a more sophisticated level, the radar and lidar scanners 14,15 can output to the processing unit (processing portion 16) both bearing and range data. This is combined with the camera data in confirming the position of the tagged survivors. However for autonomous recovery of the survivors 2 their position determined in this manner is unlikely to be sufficiently accurate. Recovery by a powered ramp is expected to require positioning to within one metre or better.

From tens of metres, the visible light camera 11 and the thermal camera 12 are expected to be able to provide recognisable images. The radar and the lidar are too. The relative clarity of their individual images will vary according to prevailing conditions, day/night, sun/rain, wind and sea state.

The processing unit 16 may be adapted to combine the images of the survivors 2 from the four sensors 11,12, 14,15. Thus for instance a survivor facing away, but with outstretched arms having fluorescent strips 5 is able to be recognised as such without sight of his/her face. Where the operation is autonomous and not able to rely on human recognition, the processing unit 16 is provided with a library 20 of images of survivors at a multitude of orientations both in the horizontal plane and in the vertical plane to take account waves pitching and rolling the survivors. The processing unit is thus expected to be able to accurately identify the number survivors and keep track of them individually.

Certain wreckage may appear at first sight to be survivors, for instance an inflated but unoccupied lifebuoy. The processing unit can be programmed to ignore such wreckage, due to absence of outstretch arms or of any thermal emission, for instance, or indeed lack of sufficient similarity with any image in the library.

Once the survivors and the wreckage, including large objects such as the body of the helicopter are identified, electronically tagged and their position accurately recorded, the processing unit identifies an electronic fence around the survivors within which the vessel should not approach. The perimeter of the fence, and its distance from the individual survivors will be determined seamanship parameters.

The survivors can be expected to drift with wind and possibly tide. The vessel is expected to drift faster. The processing unit can be adapted for autonomous recovery of the survivors by control of the conning system 18 of the vessel, or indeed autonomous conning preparatory to pilot controlled recovery, to hold the vessel at the electronic fence, until an autonomous or pilot decision is made to breach the electronic fence and recover the survivors.

The invention is not intended to be restricted to the details of the above described embodiment. For instance, the thermal camera can be augmented or replaced by an infrared transceiver adapted to emit IR and receive its reflections. This and indeed the visible light and thermal cameras need not be forwards facing. They can be 360° devices, either multi-facetted, i.e. having multiple sensors with overlapping fields of view, or fisheye.

The life boat 3 may also include the features described in WO2019/158904, which is incorporated herein by reference. Thus within the location of the survivors 2, i.e. within tens of metres, but not close enough for him/her/them to necessarily swim to and board the lifeboat, the control unit may be adapted to use direct survivor location. For this it may be provided with visible light, e.g., binocularly arranged cameras mounted atop the bridge to scan the surrounding sea and detect survivors 2, typically by recognising their survival suits 4 by their yellow colour. In addition infrared cameras 12 may be mounted adjacent the visible light cameras 11 can detect heat emitted from the faces of the survivors 2. The individual survivors may be identified by the control unit 16 by numbers on their suits and/or even facial recognition technology. A wind direction and speed meter may also be provided. The control unit 16 can then manoeuvre the lifeboat 3 to head downwind of the survivors 3 and manoeuvre upwind to them positioning the recovery ramp with a nearest one of the survivors 3 for him/her to be drawn up the ramp and be pulled onboard, the ramp having been activated. This operation and indeed the initial approach to the survivors 3 can be fully under the control of the control unit 16,17; or alternatively control can be by a remote operator, utilising the GPS information and the camera information transmitted to the operator. The control unit 16,17 is expected to be able to utilise PLB data etc, provided that a plurality of PLB devices can be discriminated. Further the control unit is preferably programmed to keep track of the relative position of multiple survivors, including the ability to memorise the expected position of one or more survivors temporarily out of sight behind a wave. It can be expected that in the envisaged use of the lifeboat, in particular offshore, that survivors requiring rescuing will be wearing at least life jackets and normally survival suits and that these will be equipped with personal locator beacons (“PLBs”). Some PLBs transmit signals enabling tracking satellites to transmit to earth information for fixing the position of the PLB, whilst others in addition have GPS capability, whereby they can compute their position and transmit this directly.

The invention has been described in the context of survivors 2 equipped with survival suits 4. The invention can be useful in other man-overboard and rescue situations, where survivors 3 may be wearing merely ordinary clothes. Necessarily these will be more demanding of the location apparatus 17 with image recognition playing a more important part in locating a survivor 3.

Moreover, the location apparatus 17 is not limited to being carried on a vessel. Cameras 11,12,14,15 may be mounted on other craft, including drones and aircraft, and feed the outputs to the processing portion 16 of the location apparatus 17. The processing portion 16 may located away from the rescue vessel too but in communication with the cameras 11,12,14,15. The location apparatus 17 may be able to control the life boat 3 remotely to the survivors 2.

1. An apparatus for locating a body, comprising:
a plurality of receiving means for receiving emission and/or reflection from the body and for outputting a response in terms of presence and bearing when such emission or reflection is received;
comparison means for comparing the output response from the different receiving means and generating a body present output if output responses received from at least two of the receiving means indicate substantially the same bearing; and
memory means for memorising such a body present output as a body location.

2. An apparatus for locating a body according to claim 1, wherein at least one of the receiving means is adapted to output a response in terms of body range, whereby the body location can comprise a range and bearing of the body.

3. An apparatus for locating a body according to claim 1, wherein the comparison means is adapted to generate a body present output if one of the receiving means receives a signal characteristic of its mode of operation at one bearing and another receiving means receives a signal characteristic of its different mode of operation at substantially the same bearing.

4. An apparatus for locating a body according to claim 1, wherein each of the plurality of receiving means comprises one or more sensors and/or detectors.

5. (canceled)

6. (canceled)

7. An apparatus for locating a body according to claim 1, wherein the plurality of receiving means comprises at least one thermal sensor, optionally an infra-red sensor with sensitivity in a wavelength range of 1.3 to 4 μm and/or sensitivity in a wavelength range of 8-12 μm.

8. An apparatus for locating a body according to claim 7, wherein the at least one thermal sensor is adapted to sense infra-red emission emitted from at least a face of the body.

9. An apparatus for locating a body according to claim 7, wherein the at least one thermal sensor is adapted to sense a temperature difference between a survival suit on the body partially exposed to the air from that of the surrounding sea, at least at closer range, such as a range of less than 200 m.

10. (canceled)

11. An apparatus for locating a body according to claim 7, wherein the at least one thermal sensor is adapted to sense light with the spectrum expected from reflection off fluorescent strips.

12. (canceled)

13. An apparatus for locating a body according to claim 1, wherein the plurality of receiving means comprises at least one visible light sensor having sensitivity in a wavelength range of 380 to 750 nm.

14. An apparatus for locating a body according to claim 13, wherein the at least one visible light sensor is adapted to sense light with the spectrum expected from reflection off reflective strips.

15. (canceled)

16. (canceled)

17. An apparatus for locating a body according to claim 11, wherein the at least one visible light sensor is combined with (the) at least one thermal sensor in binocular form such that the combination of the at least one visible light sensor and the at least one thermal sensor are adapted for generating a response indicative of range.

18. An apparatus for locating a body according to claim 1, wherein the plurality of receiving means comprises at least one sensor able to time reflected emissions from the sensor for sensing the range of the body.

19. (canceled)

20. An apparatus for locating a body according to claim 1, wherein the plurality of receiving means comprises at least one infrared (IR) sensor, optionally at least two infrared (IR) sensors.

21. (canceled)

22. An apparatus for locating a body according to claim 1, wherein the plurality of receiving means are configured to additionally output a response in terms of shape of the body when such emission or reflection is received.

23. An apparatus for locating a body according to claim 22, wherein the response in terms of shape of the body is output in a common format from each of the receiving means.

24. An apparatus for locating a body according to claim 23, wherein the common format is a visually recognisable image.

25. An apparatus for locating a body according to claim 22, wherein the comparison means is adapted to compare the shape output response from different receiving means.

26. An apparatus for locating a body according to claim 25, wherein the comparison means is configured to generate a body present output if output responses received from at least two of the receiving means indicate substantially the same shape output.

27. An apparatus for locating a body according to claim 22, wherein the comparison means is adapted to compare the shape output response from the different receiving means with a collection of body images.

28. An apparatus for locating a body according to as claimed in claim 27, wherein the comparison means is adapted to generate a body present output if an output response received from at least one of the receiving means matches at least one of the collection of body images.

29. An apparatus for locating a body, comprising:
data receiving means for receiving data from the body comprising:
a) a visible light image receiver or camera;
b) an infrared or thermal image camera, receiver or transceiver; and
c) radar apparatus and/or lidar apparatus;
wherein each of a), b) and c) of the data receiving means are configured for receiving data from a body relating to least one of presence, range and bearing of the body; and
processor means for processing data received by a), b) and c) and for combining the data received by a), b) and c) to form a combined range and bearing of a body that is identified and output as being present.

30. (canceled)

31. An apparatus for locating a body according to claim 1, comprising an image creating means for creating an electronic image of the body present output and/or for creating an electronic image of its bearing.

32. (canceled)

33. An apparatus for locating a body according to claim 1, comprising change tracking means for tracking changes in range and bearing of a body that is identified as being present.

34. An apparatus for locating a body according to claim 1, wherein the apparatus is configured for installation on a vessel and comprises inputs for the vessel, wherein optionally the inputs comprise data describing the velocity and/or heading of the vessel.

35. (canceled)

36. (canceled)

37. An apparatus for locating a body according to claim 1, wherein the apparatus is configured to output conning data to a vessel based on the bearing of the body identified as being present to direct the vessel to the body.

38. (canceled)

39. An apparatus for locating a body according to claim 37, where the conning data directs the vessel to maintain a fixed distance from the body.

40. An apparatus for locating a body according to claim 1, comprising one or more detectors and/or sensors adapted to monitor the surface of the water for floating and/or partially submerged objects.

41. (canceled)

42. (canceled)

43. (canceled)

44. A vessel comprising an apparatus for locating a body according to claim 1.

45. (canceled)

46. (canceled)

47. A method for locating a body using an apparatus for locating a body in accordance with any preceding claim, the method comprising:
receiving emission and/or reflection from a body at the plurality of receiving means for receiving emission and/or reflection from the body;
outputting from the receiving means a response in terms of presence and bearing when such emission or reflection is received;
comparing the output response from the different receiving means with the comparison means for comparing the output responses;
generating a body present output with the comparison means if output responses received from at least two of the receiving means indicate substantially the same bearing; and
memorising such a body present output as a body location at the memory means for memorising.

48. A method for recovering a body, the method comprising:
locating a body in accordance with the method of claim 47;
conning a vessel to the body location that has been memorised at the memory means for memorising; and
recovering the body onto the vessel.

49. (canceled)
